(19) United States
(12) Patent Application Publication
(10) Pub. No.: US 2013/0262139 A1
(43) Pub. Date: Oct. 3, 2013

(54) Payer Governed American Medical Information Network (AMIN): Patient, Provider and Payer Federated Healthcare Information Hub.

(71) Applicant: AMIN SALAHUDDIN, Maple Shade, NJ (US)

(72) Inventor: AMIN SALAHUDDIN, Maple Shade, NJ (US)

(21) Appl. No.: 13/434,880

(22) Filed: Mar. 30, 2012

(51) Int. Cl. G06Q 50/22; G06F 19/00

(52) U.S. Cl. CPC G06Q 50/22; G06F 19/322
USPC 705/3; 705/2

(57) ABSTRACT

American Medical Information Network (AMIN) is a cohesive healthcare information hub interlinking three core components by utilizing computer software technologies. The first component is a secured shared web site, which interconnects patients and all “Covered Entities” of Health Insurance Portability and Accountability Act (HIPAA) on a common interface. The second component is a secure public cloud; a host consists of database where all registered user's profile and HIPAA privacy rules are stored with a profile service interfacing the database. Another service, which resides in the secure public cloud, is exchange service to communicate with multiple trading partners including healthcare payer's private domain. The third component of AMIN is payer's private domain, consisting of four services and a software application tool. The application tool provides the capability to dynamically build, expose and govern the functions of main service and publish the function's presentation layer on a shared web interface.

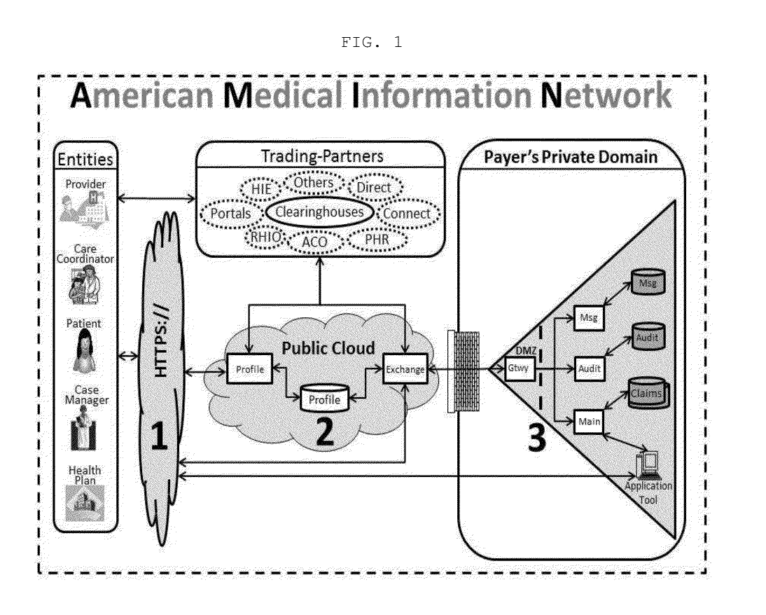

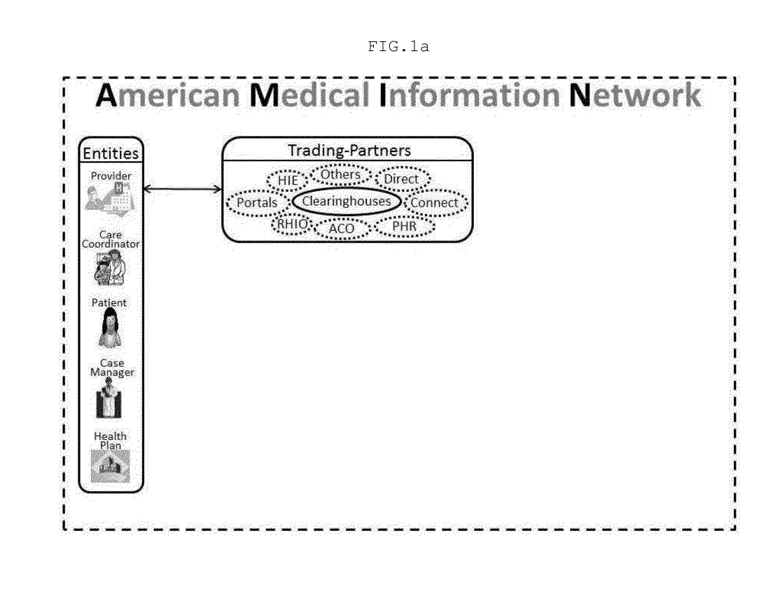

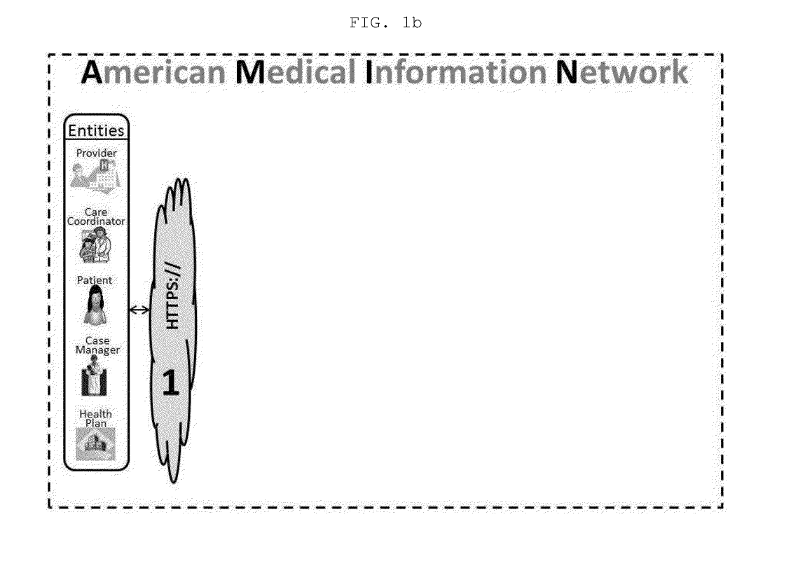

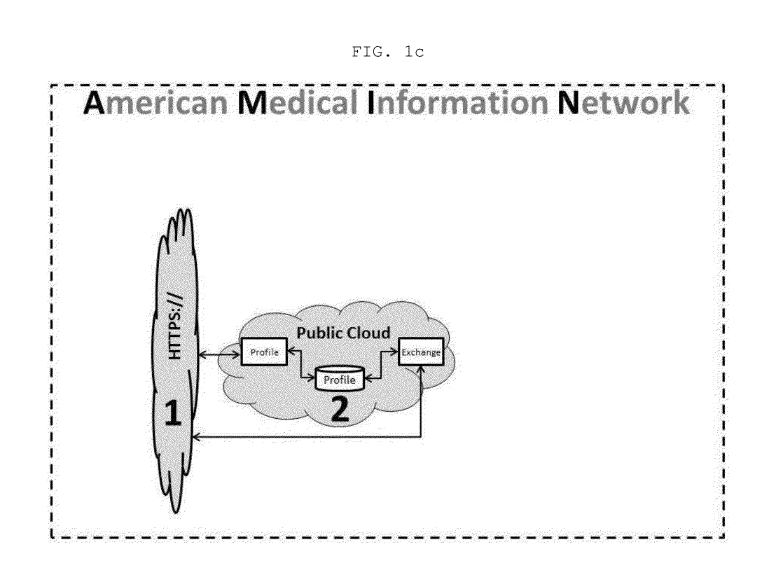

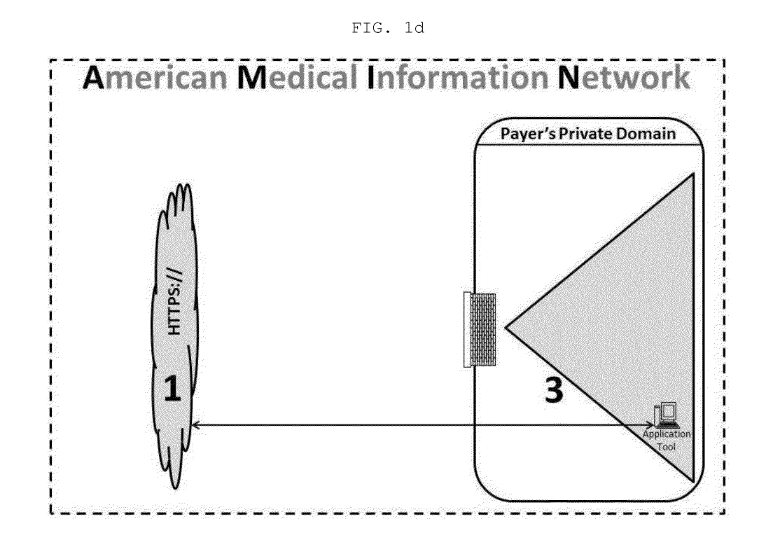

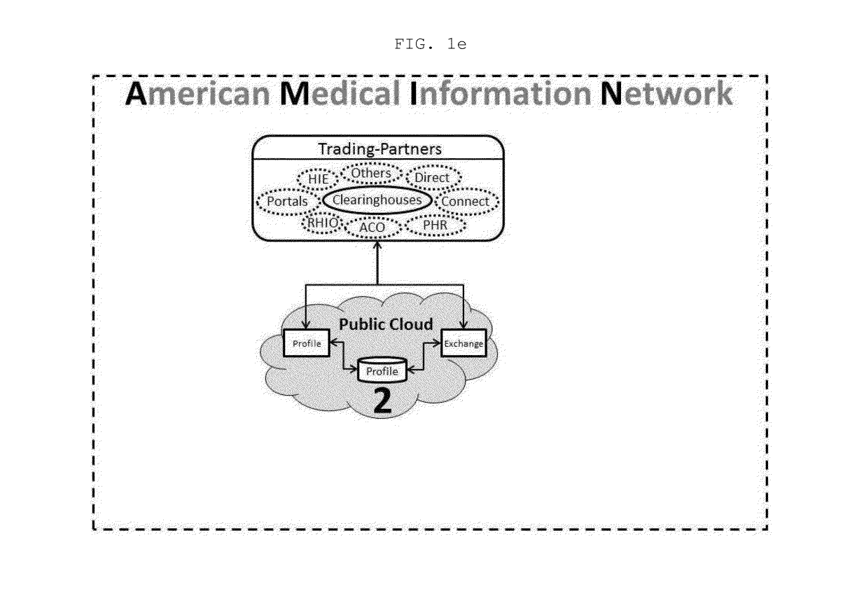

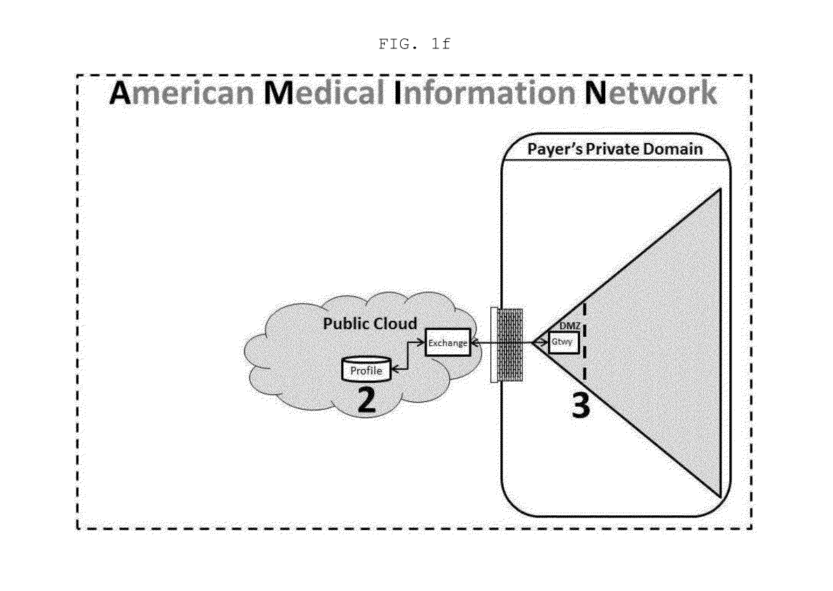

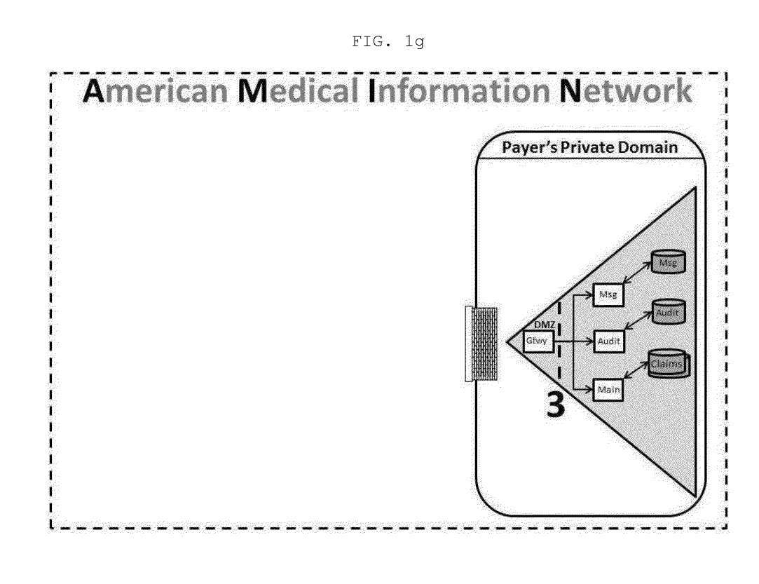

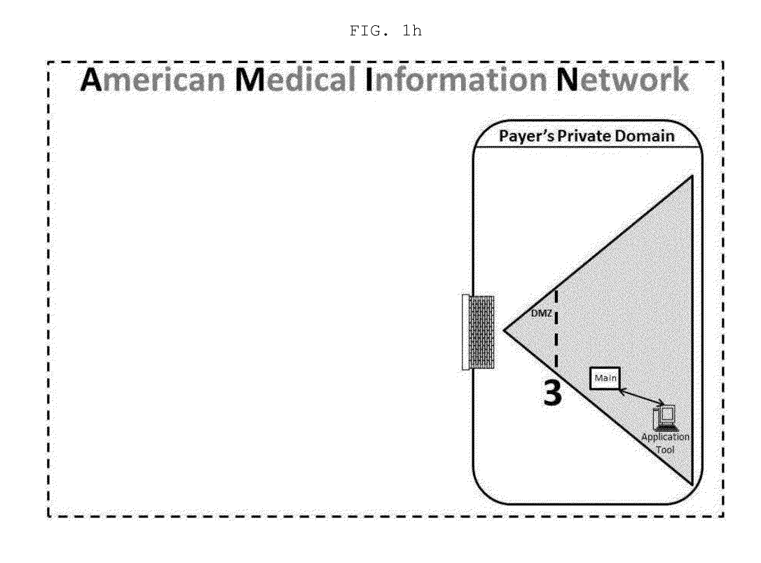

### BACKGROUND OF THE INVENTION

Average payer's current administrative cost is drastically high and still increasing due to its Information Technology (IT) enterprise infrastructure, application development and maintenance. This raises a concern because Affordable Care Act has put a limit on healthcare payers for administrative cost. Another concern is that, payers operate their business on various software applications and platforms and each application utilizes different data exchange formats. Many business processes are scattered and some application functionalities are redundant, making it cumbersome to track process inventory and becomes burdensome in system maintenance, upgrades or business expansion. For example health plans invest comprehensively in two major areas with redundant functionalities. First area is software applications utilized in customer service department for providers; the redundancy can be seen in provider self-service portals, medical management and with vast array of subsystems. Second area of investment is software for member service department and redundant functionalities can be found in member self-service portals to allow insured members to perform their requests of selected services at their own leisure.

The complexities and redundancies do not end at the payer's side, but extends across all entities of healthcare, for example let's look at the situation from a patient perspective. Every time the patient receives treatment HIPAA privacy agreement and disclosure agreement is signed for authorization or revoke the disclosure. Though this sounds reasonably simple, but difficult for the patient to keep track of all the forms being signed and their current status. The additional burdens on patients are various patient portal logins provided by different healthcare providers and keeping track of them. Unfortunately there is no universal portal for coordination of care.

Health Plans have three options, first continue to move forward with their existing approach and eventually acquire a technology savvy health plan or be acquired by one. Second, outsource IT jobs for cost savings and continue to increase independent software systems, which itself is a short term solution. Third, take a radical innovative approach to simplify and unify health plan business processes.

### SUMMARY OF THE INVENTION

The core competency of American Medical Information Network (AMIN) is to provide a platform for healthcare payers to bring their ideas rapidly into execution. The novel approach of constructing a payer governed information exchange hub by linking three key components and interconnecting various subsystems and functional aspects of each component is accomplished using AMIN. The three key components are a secure public web interface, public cloud and healthcare payer's private domain. AMIN delivers a framework to build a patient centric, patient, provider and payer federated health information network to improve coordinated medical care and reduce healthcare administrative cost. Health insurance payer can utilize AMIN to transform business operation ideas rapidly into cloud based architecture.

The first component, secure public web interface is a cohesive approach, which creates synergy in healthcare administration and patient care by interconnecting patient and all “Covered Entities” of Health Insurance Portability and Accountability Act (HIPAA) on a common web interface. There are two functional layers within web interface, web administration and payer governance. These layers allow both the administrators of AMIN to manage the web site and for payers to develop ideas rapidly into a service model.

The second component, secure public cloud consists of databases and web services. The databases contain user profile and routing settings and store all types of user's settings to build the user interface dynamically and rules to exchange messages. The services' functions as to retrieve and update user profile data and also exchange medical data with Health Information Exchange, Nationwide, Health Information Network (NHIN), clearinghouses and payers.

The third component, payer's private domain consists of multiple services and databases to store data exchange and user dashboard message logs Services such as Gateway service as a message broker residing in a demilitarized zone to deliver the message in the secure network. The second service is to retrieve and send a dashboard message to web interface. Another service is to maintain the exchange log for accountability of disclosure reporting and finally, the main service, which connects with all database sources to retrieve or update data. Besides services, the private domain includes an application tool to build a data source mapping rules and how payer's domain interacts with the user interface.

### DETAILED DESCRIPTION OF THE INVENTION

The three key components of AMIN are as following:
1. (Component 1) A secure public web interface (https) is a user interface and central location for all entities (health plans, providers, care coordinators, case managers and patients) to login. Every time user Logs In a message is sent to “profile manager” and “exchange manager” in public cloud, the 2^{nd} Component. Entities do not have to use or transition towards the secure public web interface; they can continue using their existing trading partners.
2. (Component 2) Public Cloud has two main services, a “profile manager” and the “exchange manager.” The profile manager processes the message and builds the interface according to individual user role, permission and settings. The “Exchange Manager” communicates to exchange data with other exchange networks, health plans and trading partners according to predefined rules set by the health insurance payer.
3. (Component 3) The Private Domain of a health insurance payer is Service Oriented Architecture (SOA) consists of gateway, audit, message and main service. This service is designed to interact with the source database via mapping rules and data formatting rules, which are configured and published by “Application tool.” The same application tool builds data presentation and exchange rules to be consumed by public web domain.

The three key components, which will be defined in details, are a secure public web interface, public domain and healthcare payer's private domain. This descriptive approach will lead towards how to build a payer governed, patient, provider and payer federated health information network to improve coordinated patient care as a patient centric model as well reduces healthcare administrative cost. Through this approach, we will learn how health insurance payers will be able to rapidly transform business operation ideas into cloud based architecture.

All the “Entities” in component 1 can connect with any “Trading Partners”. This option gives all “Entities” to keep their existing trading partner agreement and utilize the services provided by them. “Entities” can also utilize the first component, the secure public web interface. The first component consists of two structured layers, the presentation and service layer. The presentation layer is administered by the domain administrator, which consist of user registration (All “Entities”), login page, company information, or other miscellaneous web pages. Once the user has created an account and logs into the system the service layer (Second Layer) becomes active. The service layer screen contains predefined sections such as available services, profile control panel and message dashboard sections. The service layer also contains behavior rules such as when the service is selected, which schematron file to load. The service layer page is designed to be refreshed dynamically as it reads the Extensible Markup Language (XML) schematron files built by “Application Tool”. By default there are no services available for any user type except for setting up the user profile settings. All services are later added and exposed by health insurance carriers by using the “Application Tool” residing in the third component.

The second component, secure public cloud consists of database to store user profile, trading partner profile and patient's HIPAA privacy rules. The database interfaces with web services to maintain and exchange the current settings defined by the users. At the time when the user logs in, a secure encrypted request is sent to the profile service, which returns user settings. Each time a user selects a different insurance carrier the service layer requests a refresh call to the profile service. Similarly, the profile service can be invoked by any approved trading partner and retrieve current patient HIPAA privacy settings and process medical information exchange accordingly.

The second service (exchange service) of public domain contains the industry standard rules for data exchange format such as X12, NCPDP, XML and HL7. The exchange service connects with external trading partners and health information exchange projects (HIE, Direct, Connect . . . ). It processes approved synchronous messages with payer's private domain (Gateway Service). The “Exchange” service processes transactions with any registered and approved trading partner, defined by the payer. Payers can use “Application Tool” (An application in the 3^{rd} component) and set rules in “Main” Service for trading partners. This approach eliminates the need for a healthcare payer to build exchange gateway applications to exchange electronic medical records, HIPAA Administrative Simplification transactions or any other transactions.

The third component, payer's private domain, which consists of multiple new\existing databases and services. The newly created database (Audit), stores all transactional logs to report accountability of disclosure as defined by HITECH act and all triage messages, which are generated by payer, provider or patient. There are other existing databases, such as claims, enrollment, provider network and, etc. . . . these databases are utilized to retrieve information and provide updates. The service layer of public web domain sends a request to the “Exchange Service”, which connects with “Gateway service” residing in a DMZ of the selected healthcare payer. From here the Gateway service calls a specific service (Msg, Audit, and Main) based on the function. If a healthcare payer does not support DMZ, then the message is sent directly to the specific service via a secure channel.

Gateway service of payer's private domain also serves as a message broker residing in a demilitarized zone to exchange messages with all services in the secure network. The Gateway service also communicates with Exchange service residing in the public cloud.

Message service of payer's private domain, serves as a retriever of dashboard messages. When a user logs in and selects a healthcare payer, a message is generated to retrieve specific dashboard messages from the selected healthcare payer. The service layer of public web domain sends a request to the “Exchange Service,” which connects with “Gateway service” of the selected healthcare payer. The Gateway service calls the “Message service” to perform inquiry by selective user from message database and retrieves all messages for the specific user and responds back to the Gateway service. The message travels to the originator (Service Layer) and populates the message dashboard. Any registered user within a network of (Patient, provider, payer) can generate, deliver, update and track a message for better coordination of care through storing the message on insured's primary health insurance private domain.

Audit Service of payer's private domain is designed to function as processing patient medical records disclosure inquiry, provider statistical inquiry and payer's auditing for billing and reporting. The audit service logs each request and responses in the Audit database to maintain the exchange log for accountability of disclosure reporting. This service also generates alerts upon disclosure depending upon user profile settings on the public web domain.

The Main service of payer's private domain contains the data mapping, extracting and formatting rules in the schematron files being produced by Application Tool residing in the 3^{rd} component. The main service connects with all database sources to retrieve or update payer's data and packages in a compliant format. This service contains a universal data exchange message formatting rules to comply with industry data exchange standards. The Application Tool builds functions for web service layer and main service in the private domain. The functions are not limited to HIPAA Administrative Simplification approved transactions (Eligibility Inquiry, Claims Status Inquiry, Referrals, Prior Authorizations, Claims Submission, etc. . . . ) and HITECH Act's Electronic Medical Record, but any functions, which include exchanging electronic data (e.g.: ID Card Requests, Changing Primary-Care Physician, images, reports, etc. . . . ).

Through this holistic approach healthcare payers can dynamically build services in their private cloud and then expose them on a public web interface. AMIN builds a cohesive method to create synergy by interconnecting all “Covered Entities” of Health Insurance Portability and Accountability Act (HIPAA) through providing a common web interface to healthcare payers, providers and patient. As a payer governed health information network, AMIN transforms health insurance payer's business operation functions towards cloud based architecture.

Healthcare providers will gain the opportunity to interactively communicate electronically with patients without building individual portals for their patients. The dashboard will be utilized as an electronic triage service for healthcare providers, and receive e-messages, alerts and action items from all entities within their network. This approach eliminates redundancies and simplifies tracking of all phases of patient care at a central location, which improves quality of medical care.

The patient can centrally define patient HIPAA privacy, disclosure consent, data exclusions and sensitive data suppression rules. Patient defined rules can be read by all healthcare “Covered Entities” and their “Business Associates” before they disclose any information. Patients will further gain the opportunity to monitor all disclosures of their personal health record by any health care entities and receive medical disclosure alert notification. Patients can also electronically consult with care givers on non-emergency urgent matters, request medication refill, and schedule an appointment to seek medical treatment.

The phenomenon of the common platform for all entities involved in patient care, including the patient, leads towards enhancement in coordinated care as specified in Affordable Care Act. Through adopting American Medical Information Network, healthcare payers can integrate HIPAA “Administrative Simplification,” HITECH Act's exchange of electronic medical records and comply with HIPAA and CORE standards all part of one system. The rich features and capabilities of AMIN unify healthcare IT system and transition's healthcare payers on cloud architecture to bridge the information gap.

1. A multi-payer self-operated medical information network providing all healthcare entities such as patient, payers, providers, patients, case managers, home health providers and care providers a cohesive approach on a single platform to communicate with one another in a synchronous mode to bridge the information gap.

2. (canceled)

3. (canceled)

4. Provides synchronous on demand accountability of disclosure report, so the patient can track “who”, “when” and “why” their personal health record was accessed.

5. Serves as a communication platform to exchange multiple types of alerts and action items to be taken by any registered healthcare entity.

6. (canceled)

7. (canceled)

8. (canceled)

9. (canceled)

10. (canceled)

11. (canceled)

12. (Canceled)

13. (Canceled)

14. (Canceled)

15. (Canceled)

16. (Canceled)

17. (Canceled)

18. (Canceled)

19. (Canceled)
